(19) United States
(12) Patent Application Publication
(10) Pub. No.: US 2016/0285072 A1
(43) Pub. Date: Sep. 29, 2016

(54) Recycled Silver/Copper-Aluminum Battery

(71) Applicant: Sahil Doshi, Pittsburgh, PA (US)

(72) Inventor: Sahil Doshi, Pittsburgh, PA (US)

(21) Appl. No.: 15/081,877

(22) Filed: Mar. 26, 2016

Related U.S. Application Data
(60) Provisional application No. 62/139,038, filed on Mar. 27, 2015.

(51) Int. Cl. H01M 4/06; H01M 6/04; H01M 6/06; H01M 4/38

(52) U.S. Cl. CPC H01M 4/06; H01M 4/38; H01M 6/045; H01M 6/06; H01M 2220/30

(57) ABSTRACT

A new type of environmentally-friendly battery comprised primarily of recycled aluminum, silver, or copper is disclosed. The battery can be created from readily-available recycled materials and formed into different shapes and characteristics, as desired.

### RELATED APPLICATION

This application claims the benefit of co-pending U.S. Provisional Patent Application No. 62/139,038, filed on Mar. 27, 2015, the contents of which are hereby incorporated by reference.

### FIELD OF INVENTION

The present invention generally relates to a battery comprised of silver or copper and aluminum. More specifically, it relates to a silver/copper-aluminum battery made from recycled materials.

### BACKGROUND OF THE INVENTION

Batteries are extremely useful devices for storing electrical energy that have been known for hundreds of years. While originally crude and inconsistent devices, experimental progress and understanding throughout the years has led to refined and efficient devices that are used in a multitude of ways to provide electrical power without having to be connected to a power grid, generator, or other type of power generating system. Batteries are used in numerous types of devices, including cars, flash lights, computers, cellular phones, and backup power supplies, to name just a small number.

In its simplest form, a battery is a device that converts chemical energy into electrical energy in a voltaic cell. Each cell is comprised of electrolyte and a positive and negative electrode (the cathode and anode), which are often separated by some material that allows ions to flow between the cells, but prevents the anode and cathode from touching. When a battery is placed in an electrical circuit and begins the discharge process, ions are produced from the oxidation reaction. So, the anode material is oxidized to produce positive ions and electrons that flow through the outer circuit. When the free electrons reach the cathode, the electrolyte reacts with the cathode and the free electrons in a reduction reaction to create a neutral compound. These reactions create a process in which electrons flow from the anode to the cathode, which, in turn, produces electricity.

In some cases, the electrolytes surrounding the anode and cathode are different, in which case a separator, such as a salt bridge, is placed between the anode and cathode to keep the electrolytes from mixing, while allowing ions and electrons to flow between the two halves of the battery.

There are a number of different types of batteries, which are often classified as being either wet cells or dry cells. A wet cell has a liquid electrolyte, while a dry cell uses a more solid material for the electrolyte, such as a paste. A variety of different materials have been used for the anodes and cathodes in batteries, such as aluminum, cadmium, carbon, chromium, copper, hydrogen, lead, lithium, gold, iron, magnesium, mercury, nickel, oxides, oxygen, silver, sodium, sulfur, and zinc, among other things. A variety of different materials have also been used as electrolytes, including calcium chloride, chloric acid, hydrochloric acid, magnesium hydroxide, nitric acid, potassium nitrate, sodium acetate, sodium chloride, sodium hydroxide, and sulfuric acid, among other things.

Modern society has increasingly turned to small, portable devices to handle all sorts of day-to-day and more specialized tasks. For example, cellular phones are nearly ubiquitous and have in many cases supplanted landlines for many households. Computer tablets, such as iPads, are also disrupting traditional information devices, such as televisions and radios. The advancements in LED technology have also made flashlights more efficient and longer lasting. In short, there is an increasing need for individuals to have access to battery-powered devices, especially in this modern age.

Batteries are not without their drawbacks, though. First, they are often made of materials that are toxic or otherwise harmful to people and the environment, which makes it difficult to dispose of them once they no longer function or are no longer needed. Second, maintaining or acquiring batteries can be expensive, especially for individuals of lower income or who are located in areas of the world that are less developed than the United States.

Thus, there is a need for a more environmentally friendly and cost-effective battery that can coexist or be made adaptable to devices in the marketplace that use conventional batteries.

### SUMMARY OF THE INVENTION

The present invention addresses the issues of environmental impact and expense by using materials that are environmentally less impactful because they are made, at least in part, from recycled materials. By using recycled materials, the invention addresses at least two environmental problems. First, constructing batteries does not require the acquisition or manufacture of new materials that are either harmful in and of themselves or must be obtained from processes that have a significantly negative environmental impact. Second, the use of recycled materials removes waste from the stream of commerce, thereby lessening the load on waste disposal facilities and the environment.

In particular, one embodiment of the invention uses carbon dioxide, recycled aluminum, and recycled silver to generate a compact, light-weight battery that produces more than 1.0 volts of electricity. Another embodiment can use recycled copper in place of the recycled silver. Yet another embodiment can use combinations of new and recycled aluminum, silver, or copper.

Embodiments of the invention can be used in a wide variety of ways. For example, they can be used to create inexpensive sources of electrical energy for use in communities with less access to resources or wealth (such as in less developed countries). They can be used in environments that create carbon dioxide (such as manufacturing plants) as one way to process or capture the carbon dioxide. They can also be used to replace conventional batteries in household products to decrease the environmental impact of having and using a battery.

### DESCRIPTION OF THE DRAWINGS

FIG. 1 is a diagram of one embodiment of a wet cell battery with an internal separator.

FIG. 2 is a diagram of one embodiment of a wet cell battery with a salt bridge.

FIG. 3 is a diagram of another embodiment of a wet cell battery with a salt bridge.

FIG. 4 is a top view of one embodiment of a dry cell battery.

FIG. 5 is a side view of one embodiment of a dry cell battery.

FIG. 6 is a side view of one embodiment of a dry cell battery with a series of electrochemical cells connected in series.

FIG. 7 is a top view of one embodiment of a cylindrical dry cell battery.

FIG. 8 is a side view of one embodiment of a cylindrical dry cell battery.

FIG. 9 is a side view of one embodiment of a cylindrical dry cell battery.

### DETAILED DESCRIPTION

A battery is an electrochemical device that uses chemical reactions to generate electrical energy. A battery can be comprised of one or more electrochemical or voltaic cells. An electrochemical cell is generally comprised of an anode, a cathode, and one or more electrolytes that surround the anode and cathode. The anode is a negative electrode that attracts negatively charged particles (ions or electrons), and the cathode is a positive electrode that attracts positively charged ions. The electrolytes in the cell react with the anode and cathode to create an excess of electrons near the anode and an excess of positively charged ions near the cathode. When the anode and cathode are electrically connected outside of the cell, such as by being placed in a circuit, the excess electrons can flow through the electrical connection to the cathode, thereby generating an electric current. At the same time, positively charged ions created at the anode flow internally through the electrolytes to the cathode to balance the electrical flow.

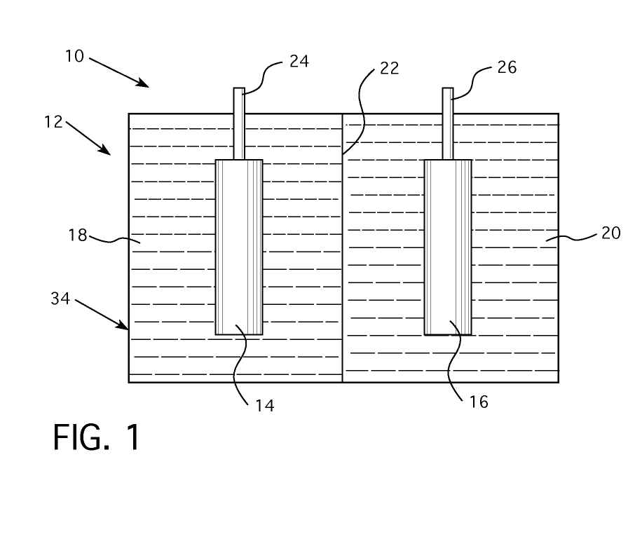

As shown in FIG. 1, battery 10 is generally comprised of at least one electrochemical cell 12, although more than one electrochemical cell can be connected together to form a larger battery with different characteristics. Electrochemical cell 12 is comprised of anode 14 and cathode 16. Electrolyte 18 surrounds anode 14, and electrolyte 20 surrounds cathode 16. Separator 22 physically separates electrolyte 18 from electrolyte 20 and anode 14 from cathode 16 while allowing current to pass through separator 22. Terminals 24 and 26 are electrically coupled to anode 14 and cathode 16, respectively, to provide a place to electrically connect battery 10 to a circuit or other device. Electrochemical cell 12 is contained within a non-conductive housing 34 (such as a plastic form or a metal form with a non-conductive coating or cover, among other things) that protects and contains the contents of electrochemical cell 12. When anode 14 and cathode 16 are electrically connected across terminals 24 and 26, such as by an electrically conductive wire or circuit, anode 14 becomes a source of electrons that flow from anode 14 through terminal 24. This flow of electrons gives rise to a current in electrochemical cell 12 that can power an electrical device connected to battery 10.

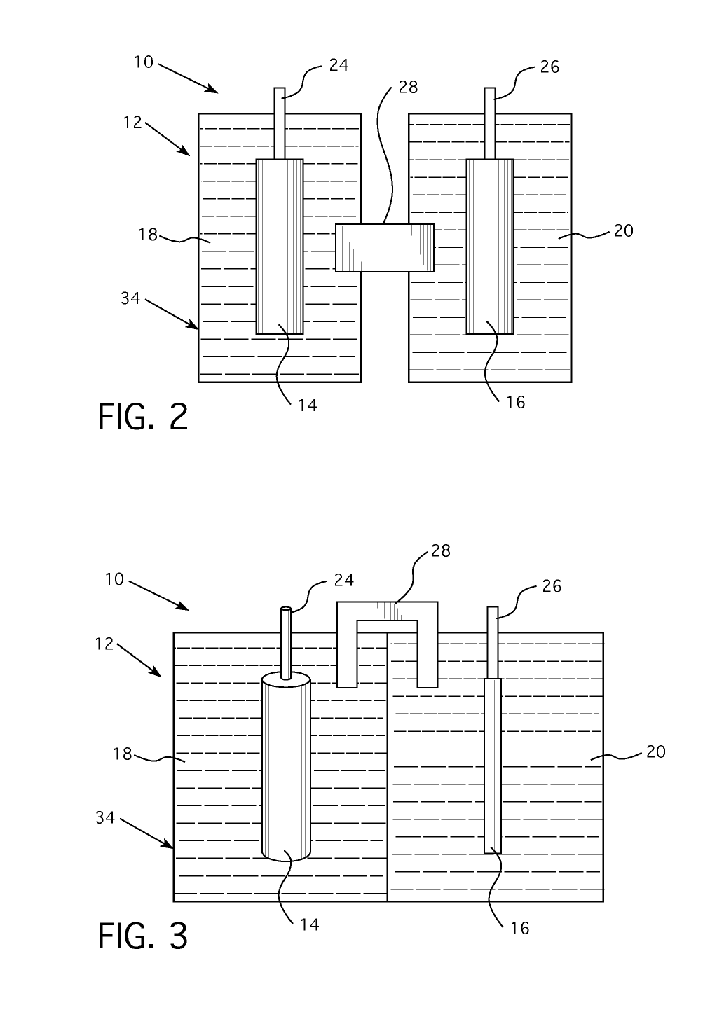

As shown in FIG. 2, the components of battery 10 can be arranged in different ways. For instance, instead of using separator 22, electrolytes 18 and 20 are physically separated in different containers. Salt bridge 28 acts as the medium through which charged particles travel from cathode 16 to anode 14.

One example of this embodiment shown in FIG. 3 was created by mixing 75 mL of carbonic acid with two teaspoons (approximately 10 mL) of table salt (sodium chloride). This solution was electrolyzed for 15 minutes using a standard household 9-volt battery (PP3) and placing an 8.5″×11″ piece of household aluminum foil 14 that was rolled into the shape of a cylinder into the solution to form electrolyte 18. A second solution was prepared by mixing another 75 mL of carbonic acid with two teaspoons (approximately 10 mL) of table salt (sodium chloride). A 1.75″ length of silver-plated copper guitar string or wire 16 was then placed into the second solution, which was electrolyzed for 15 minutes using a 9-volt battery and a 1.75″ length of silver-plated copper guitar string or wire to form electrolyte 20. Other conventional electrolyzation methods could be used and fall within the scope of the invention. Once both solutions were electrolyzed, salt bridge 28 in the form of a rolled up paper towel was placed so that the opposite ends of the paper towel were immersed in both solutions, although other materials that allow the transfer of charged particles (such as fabric or meshes, among other things) could also be used. This configuration created a wet cell.

In this configuration, the electrolyte reaction was:

NaCl(s)+H₂CO₃(aq)→H₂CO₃(aq)+Na⁺(aq)+Cl⁻(aq)

And, the reduction-oxidation reaction was:

Al(s)+3Ag⁺→Al³⁺(aq)+3Ag(s)

By combining aluminum anode 14, electrolytes 18 and 20, salt bridge 28, and silver cathode 16 in the manner described above, a battery can be formed that can produce 0.65 volts of electricity when electrical leads are connected to terminals 24 and 26 on aluminum anode 14 and silver-plated cathode 16.

In another variation on this embodiment, electrolyte 18 was prepared by mixing 20 mL of carbonic acid with 1.5 teaspoons (approximately 7.5 mL) of table salt (sodium chloride) and placing a 2.5″×2″ piece of aluminum foil 14 in the solution. A second electrolyte solution 20 was prepared by also mixing 20 mL of carbonic acid with 1.5 teaspoons (approximately 7.5 mL) of table salt (sodium chloride) and placing a 1.75″ length of silver-plated copper guitar string or wire 16 in the second solution. Both solutions were separately electrolyzed for 15 minutes using a 9-volt battery. Once both solutions were electrolyzed, salt bridge 28 in the form of an 11″×11″ rolled-up paper towel was placed so that the opposite ends of the paper towel were immersed in both solutions 18 and 20. This configuration also created a wet cell.

In another embodiment of the invention, electrolytes 18 and 20 are the same and are formed from a combination of carbonic acid (H₂CO₃) and salt (NaCl) that has been electrolyzed using a voltage source. Carbonic acid can be formed by dissolving carbon dioxide in water. The electrolyte mixture is then absorbed by a suitable material (such as paper, cloth, plastic, or other fabric/mesh) and placed between aluminum anode 14 and silver cathode 16. In one example, aluminum anode 14 is created from recycled aluminum foil and silver cathode 16 is created from a recycled silver-plated copper guitar string, although other sources of recycled aluminum and silver could be used and fall within the scope of the invention.

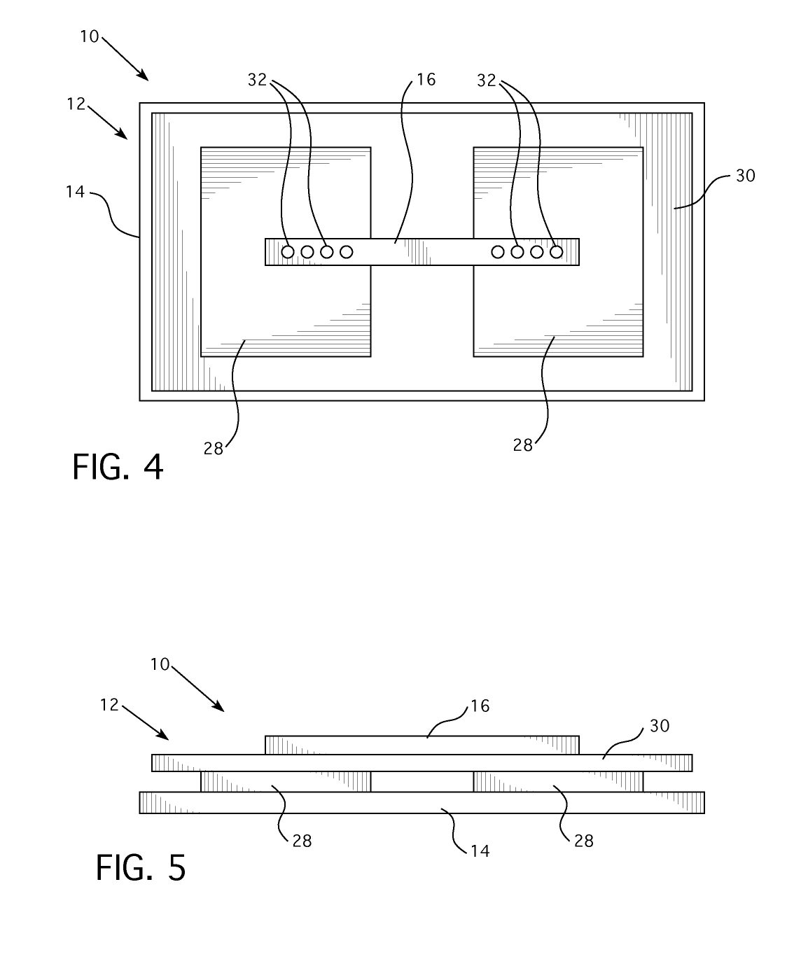

In another embodiment of the invention, shown in FIG. 4, a single electrolyte 18 was formed by combining carbonic acid (H₂CO₃), ammonia (NH₃), and salt (NaCl). A plastic/fabric mesh 28 was soaked in the electrolyte and then placed between the aluminum anode 14 and silver cathode 16 to act as salt bridge. It has been found that a 3M scouring pad or Scotch-Brite sponge can form a particularly good salt bridge, but other materials can also be used such as fabric or meshes. In order to prevent short-circuiting in configurations comprising multiple cells, an insulating material 30 (such as latex from a recycled latex glove, rubber, or plastic, among other possible things) was placed between aluminum anode 14/salt bridge 28 and silver cathode 16. Latex 30 acted as an insulator, preventing an unwanted connection between salt bridge 28/aluminum anode 14 of one cell and the aluminum anode 14 of an adjacent cell. In order for the cell to work in this configuration, holes 32 were placed in latex 30 such that there was still an electrical connection between salt bridge 28 and silver cathode 16 within the cell, but no other unwanted electrical connections.

More specifically and referring to FIGS. 4 and 5, a high-concentration of sodium chloride (15 grams of sodium chloride) was added to a solution of liquid ammonia and carbonic acid (50 mL of liquid ammonia and 50 mL of carbonic acid) to create a hydrated paste-like substance. The solution was mixed to increase salt solubility, and the remaining liquid was drained so as to only leave the salt residue in the form of a paste that formed electrolyte 18. When paste electrolyte 18 was applied to the salt bridge surface 28, the small amounts of the solution hydrated the mesh material of salt bridge 28 while the salt residue fell into the small pores on the exterior of salt bridge 28.

In this configuration, the electrolyte reactions were:

H₂CO₃+NH₄OH→(NH₄)HCO₃+H₂O

2Al+3CO₃→Al₂(CO₃)₃

And, the reduction-oxidation reaction was:

Al(s)+3Ag⁺(aq)→Al³⁺(aq)+3Ag(s)

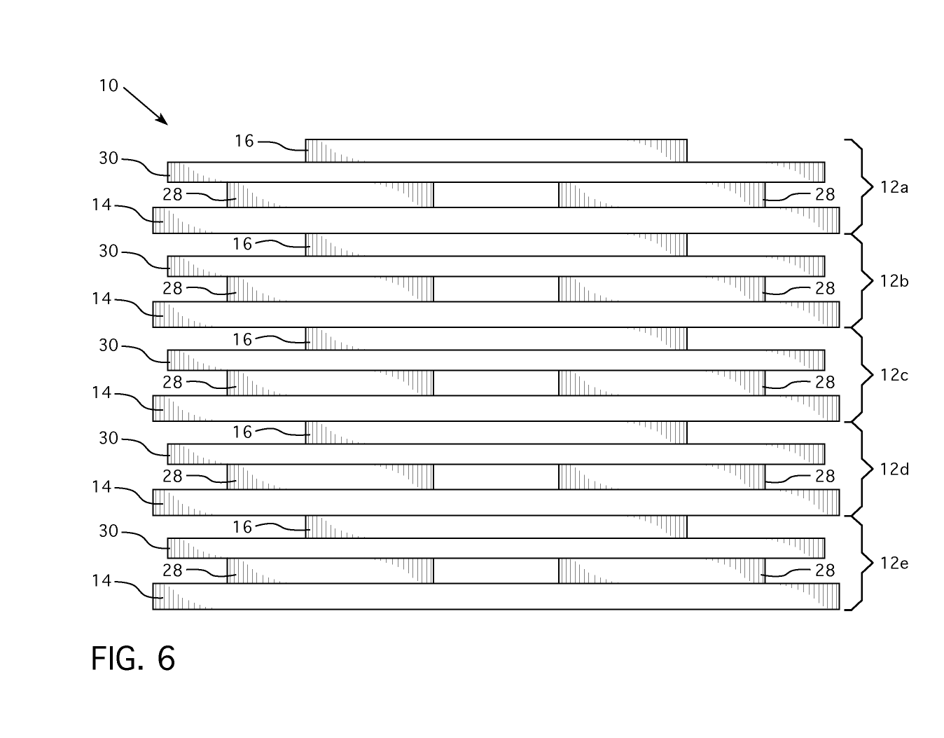

As shown in FIG. 6, by combining aluminum anode 14, electrolyte 18, salt bridge 28, insulator 30, and silver cathode 16 in the manner described above and stacking five of these cells (12(a)-(e)) on top of each other so as to connect them in series (e.g., with the cathode of one cell in electrical contact with the anode of the adjacent cell), a battery can be formed that can produce 1.5 volts of electricity.

As described above and as understood by one skilled in the art, individual cells or multiple cells can be connected in parallel, series, or a combination of parallel/series connections to create batteries with different capacities and voltages.

The components of the battery designs described above—carbonic acid, sodium chloride, aluminum, silver, and the fabric/cloth salt bridge—are made from materials that can be readily found from sources of recycled products. For example, aluminum is one of the most recycled materials on the planet, and it is relatively straightforward to obtain recycled aluminum from sources such as aluminum cans, foil, car parts, and scraps from the manufacturing of aluminum parts, among other things. Carbonic acid can be formed by mixing carbon dioxide, which is a by-product of a variety of industrial processes (such as the burning of coal, oil, or gas), with water. Silver is also readily recycled and can be obtained from a variety of sources, such as old jewelry, photographic finishers, industrial and medical x-ray waste, and wires such as guitar strings, among other things. Finally, fabric and meshes are also readily obtained from waste cloth and plastics, among other things.

The electrolytes used are generally acid-based solutions that consist of polyatomic ions and dissolved ionic compounds for enhanced ionic conductivity. For example, polyatomic ions can include carbonates, sulfates, and nitrates, among other things, and the dissolved ionic compounds can include sodium chloride and potassium chloride, among other things. As stated above, weak acid-based solutions that are primarily composed of carbonic acid have been found to be suitable electrolytes, although other electrolytes can also be used and fall within the scope of the invention.

By focusing on recycled components, the battery can be formed in a more environmentally favorable way than by using traditional components. While some embodiments are comprised of components (e.g., silver, aluminum, etc.) that are purely sourced from recycled materials, the invention can be used with embodiments that contain combinations of recycled and new materials (e.g., recycled aluminum and newly manufactured/refined aluminum, etc.). Ideally, the percentage of the anode and cathode materials sourced from recycled materials is between 75 and 100%.

In one commercial embodiment of the invention, the materials that comprise the embodiment could be acquired using a consumer-centric approach in which customers, in exchange for money, donate recycled materials, such as aluminum cans and silver guitar strings, to an assembly facility. These materials would then be reprocessed for usage in a battery by removing the non-metal portions, cleaning them, and forming them into the proper shapes and sizes, for example. In some instances, this reprocessing may require the recycled materials to be melted and formed/cast into the proper purity, shape, and size.

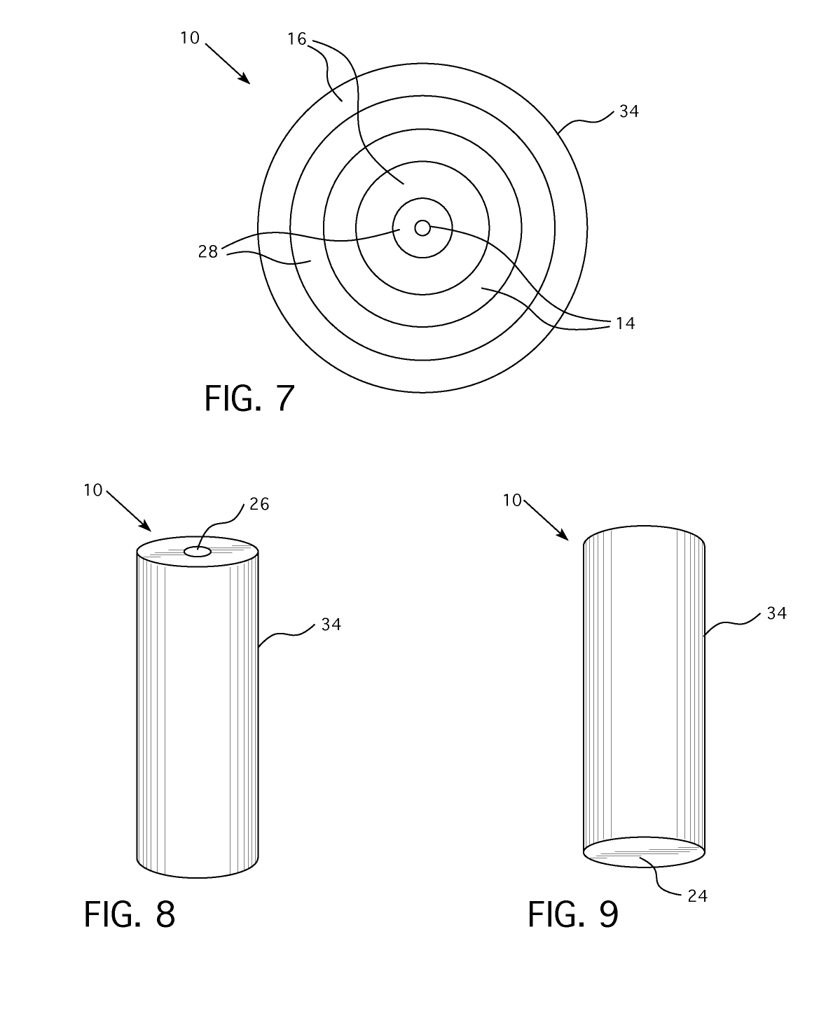

In one example shown in FIGS. 7-9, the final product could consist of a non-conductive housing 34, such as plastic, paper, cardboard, or a metal with a non-conductive coating or cover (among other things), that contains metal anode 14, salt bridge 28, and silver cathode 16. The battery would follow the voltaic-pile approach and contain the same materials as described in the dry cell embodiments above, but each component would be rolled into a cylindrical form. Each aluminum foil layer would be approximately 0.15″ wide and each salt bridge material would be approximately 0.1″ wide. Silver cathode 16 would then fit in between aluminum anode 14 and salt bridge 28 to complete the voltaic pile. A negative terminal 24 is connected to anode 14, and a positive terminal 26 is connected to cathode 16. In an alternative embodiment, anode 14 could also be housing 34. In that instance, care should be taken to insure that anode 14 is electrically isolated from terminal 26.

The amounts of each material and the number of cells can be varied to increase current and voltage respectively. For instance, more voltaic piles for higher voltage will require thinner materials within the cylindrical cell, so the aluminum and salt bridge widths will vary accordingly. This form and shape could be identical to that used in standard AA batteries or other types of cylindrical batteries.

Depending on the power requirements, availability of recycled materials, and customer needs, the internal components could be replaced with other materials and fall within the scope of the invention. For instance, copper, which is also a fairly efficient cathode, could replace the silver. Copper is widely use in a variety of products (and thereby is easily obtain as a recycled material). For example, copper could be sourced from recycled wires, pipes, coins, motors, computers, and roofing, among other things. Additionally, alternative fibrous materials with enhanced liquid retention abilities, such as superabsorbent polymers that are very capable of absorbing and retaining liquid, could replace the current scouring pad as the internal salt bridge. For instance, sodium polyacrylate, which can absorb large amounts of water, can be modified to absorb the liquid electrolyte of the battery.

The invention is not limited to just cylindrical battery designs. Other size and voltage variations can be constructed, such as rectangular forms (e.g., 9V, lantern, etc.), coin shapes, cell stacks commonly used in automobile battery technology, and others. The Tesla Model S car, for example, uses over 7,000 lithium-ion cells wired in a mixed arrangement of series and parallel connections to power to vehicle. In a large-scale energy generation setting, a large number of batteries using this invention described herein (such as approximately 10,000 cells) could be wired together and used to power a work-intensive machine, such as a car. Handheld devices and mobile electronics, which have lower power needs, could use a fewer number of connected cells (such as 50) to provide the needed power.

The foregoing description has been presented for purposes of illustration and description, and is not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although particular constructions of the present invention have been shown and described, other alternative constructions will be apparent to those skilled in the art and are within the intended scope of the present invention.

What is claimed is:

1. A battery comprising:
a housing;
an anode located within the housing and comprising at least 75% recycled aluminum;
an electrolyte located within the housing; and
a cathode located within the housing, wherein the cathode is selected from the group consisting of at least 75% recycled silver and at least 75% recycled copper.

2. The battery of claim 1, further comprising a salt bridge connecting the anode and the cathode.

3. The battery of claim 1, further comprising an insulating material located between the anode and the cathode.

4. The battery of claim 1, wherein the electrolyte is an acid-based solution comprising polyatomic ions and dissolved ionic compounds.

5. The battery of claim 1, further comprising:
a negative terminal electrically connected to the anode; and
a positive terminal electrically connected to the cathode.

6. The battery of claim 1, wherein the housing is comprised of the anode.

7. The battery of claim 1, wherein the housing is cylindrical in shape.

8. A battery comprising:
a housing;
a first anode located within the housing and comprising at least 75% recycled aluminum;
a first electrolyte located within the housing;
a first cathode located within the housing, wherein the first cathode is selected from the group consisting of at least 75% recycled silver and at least 75% recycled copper;
a second anode located within the housing and comprising at least 75% recycled aluminum;
a second electrolyte located within the housing; and
a second cathode located within the housing, wherein the second cathode is selected from the group consisting of at least 75% recycled silver and at least 75% recycled copper;
wherein the first cathode is electrically connected to the second anode.

9. The battery of claim 8, further comprising:
a first salt bridge connecting the first anode and the first cathode; and
a second salt bridge connecting the second anode and the second cathode.

10. The battery of claim 8, further comprising an insulating material located between the first anode and the first cathode.

11. The battery of claim 8, further comprising:
a negative terminal electrically connected to the first anode; and
a positive terminal electrically connected to the second cathode.

12. The battery of claim 8, wherein the housing is comprised of the first anode.

13. The battery of claim 8, wherein the housing is cylindrical in shape.

14. The battery of claim 8, wherein the first and second electrolytes are weak acid-based solutions comprised of carbonic acid.

15. The battery of claim 8, wherein the first anode and the second anode are made from the same materials.

16. The battery of claim 8, wherein the first electrolyte and the second electrolyte are made from the same materials.

17. The battery of claim 8, wherein the first cathode and the second cathode are made from the same materials.

18. A battery comprising:
a housing;
an anode located within the housing and comprising at least 75% recycled aluminum foil;
an electrolyte located within the housing and comprising an acid-based solution comprising polyatomic ions and dissolved ionic compounds;
a cathode located within the housing and comprising at least 75% recycled silver wire; and
a salt bridge connecting the anode and the cathode.

19. The battery of claim 18, further comprising an insulating material located between the salt bridge and the cathode.
